(19) United States
(12) Patent Application Publication
(10) Pub. No.: US 2021/0319364 A1
(43) Pub. Date: Oct. 14, 2021

(54) Data Analyzing Method, Data Analyzing Device, and Learning Model Creating Method for Data Analysis

(71) Applicant: Shimadzu Corporation, Kyoto-shi, Kyoto (JP)

(72) Inventors: Yuichiro FUJITA, Kyoto-shi, Kyoto (JP); Akira NODA, Kyoto-shi, Kyoto (JP)

(21) Appl. No.: 17/271,628

(22) PCT Filed: Aug. 28, 2018
(86) PCT No.: PCT/JP2018/031742

§ 371 Date: Feb. 26, 2021

(51) Int. Cl. G06N 20/00

(52) U.S. Cl. CPC G06N 20/00

(57) ABSTRACT

The present disclosure provides methods for analyzing data to be analyzed by an analysis program using an analysis parameter.

### TECHNICAL FIELD

The present invention relates to a technique used when analyzing various kinds of data including measurement data, obtained by measuring a sample using an analyzing device, by an analysis program.

### BACKGROUND ART

A chromatograph mass spectrometer combining a chromatograph and a mass spectrometer has been widely used to identify and quantify a target compound contained in a sample. In the chromatograph mass spectrometer, the sample is introduced into a chromatograph column, and a plurality of substances contained in the sample are separated according to the difference in retention time (RT) and introduced into a mass spectrometer (MS). The substance introduced into the mass spectrometer is ionized, and then, separated according to a mass-to-charge ratio (m/z) and detected. As a result, it is possible to obtain three-dimensional data obtained by plotting detection intensities of ions with respect to two axes of the retention time (RT) and the mass-to-charge ratio (m/z). In this three-dimensional data, the detection intensity (signal intensity) of the ion at each mass-to-charge ratio reflects a content of the substance, which generates the ion having that mass-to-charge ratio, in the sample.

By integrating signal intensities in a direction of the mass-to-charge ratio (m/z) axis at each point on the retention time (RT) axis of the three-dimensional data, the total ion current (TIC) is obtained. Then, a total ion current chromatogram (TICC) is obtained by plotting the total ion current along the retention time axis.

If each of the substances contained in the sample is sufficiently separated from each other by the chromatograph column, a monomodal bell-shaped peak appears at a position of the retention time of the substance in a TICC waveform. As the substance is identified from the mass spectrum at that retention time, it is possible to identify the substance that eluted at the retention time. The identification of the substance is performed by comparing the mass spectrum to be identified and the measured mass spectrum or a theoretical mass spectrum of a known substance stored in a database (DB). Items of the comparison are a mass-to-charge ratio (m/z) value at which a mass peak exists, the intensity of the mass peak, and the like. On the basis of the degree (score) of matching between the mass spectrums, it is possible to quantitatively evaluate the degree of reliability of the substance identification result. In addition, it is possible to estimate the amount of each of the substances separated by the chromatograph on the basis of the area or height of the peak on the TICC waveform.

However, if a sample contains a plurality of substances with the same or similar retention times, the plurality of substances are mixed in the eluate coming out from the chromatograph at the retention time of those substances or the time just before or after the retention time. In that case, mass peaks, derived from the plurality of substances, are mixed in a mass spectrum at the retention time or the time just before or after the retention time, and peaks of the TICC waveform obtained by integrating these mass peaks also appear as peaks where the peaks derived from the plurality of substances overlap each other. Normally, it is considered that a substance is eluted at the retention time of a peak top of a monomodal peak appearing in the TICC waveform. In the case of overlapping peaks, however, the shape of the peak is distorted, a small monomodal peak is hidden in a large monomodal peak, or a peak becomes multimodal. In such a case, it is difficult to correctly determine the retention time at the peak top. In addition, the situation becomes more complex if measurement data contains noise or a signal intensity contains a baseline component, and it becomes more difficult to obtain a retention time for a small TICC peak derived from a substance that is contained only in small amounts in the sample.

Therefore, a peak deconvolution processing is performed to separate the overlapping peaks by signal processing, statistical processing, or the like, and purify the TICC peaks such that one mass spectrum contains only mass peaks each derived from a single substance. By purifying the TICC peaks in this manner, it is possible to estimate what kind of TICC peaks overlap on a TICC waveform of the measurement data. In many cases, a dedicated analysis program is used to perform the peak deconvolution. As a typical analysis program used to purify peaks of measurement data (GCMS data) obtained by gas chromatography/mass spectrometry (GC/MS), an automated mass spectral deconvolution and identification system (AMDIS) provided by the National Institute of Standards and Technology (NIST, USA) is known (see Non Patent Literature 1). AMDIS uses six analysis parameters (peak width, omission mass-to-charge ratio, number of adjacent peaks, peak interval, peak detection sensitivity, and the degree of model conformance) to purify peaks. Initial values are prepared for each of these analysis parameters, and in many cases the initial values are used without modification.

### CITATION LIST

### Patent Literature

Patent Literature 1: JP 2007-41234 A

### NON PATENT LITERATURE

Non Patent Literature 1: “Automated Mass Spectral Deconvolution & Identification System”, [online], The National Institute of Standards and Technology (NIST), [Searched on Jun. 22, 2018], Internet

Non Patent Literature 2: “Mass ++”, [online], Shimadzu Corporation, [Searched on Jun. 22, 2018], Internet

Non Patent Literature 3: Takayuki Okatani, “Deep Learning (Machine Learning Professional Series)” Kodansha, April 2015

### SUMMARY OF INVENTION

### Technical Problem

The initial values of the analysis parameters in AMDIS are set assuming general use for various kinds of GCMS data, and are not always appropriate in some actual conditions of GCMS data (a shape of a convolution peak, a mass scanning speed, a noise state, or the like). That is, there is a case where it is difficult to sufficiently separate peaks if the initial values are used without any modification for peak deconvolution of GCMS data to be analyzed. In such a case, a user modifies the value of one or some of the analysis parameters from the initial value in order to separate the peaks, and adjusts the parameters until results regarded to be valid by an analyst are obtained, and parameter adjustment is performed until a substance is identified with sufficient reliability, that is, a sufficiently high score is obtained. At this time, the analyst adjusts the parameters based on the intuition or experience cultivated by himself/herself. Thus, there is a problem that a result of the analysis depends on the ability or feeling of the user, that is, the result thus obtained varies depending on the skill level of the analyst. In addition, there is a problem that the analysis work takes time and effort because it is necessary to repeat the parameter adjustment.

Although the case of analyzing the GCMS data by AMDIS has been described as an example of the related art, there are problems similar to the above-described problems when analyzing various kinds of data such as measurement data, obtained by measuring a sample using another analyzing device, using some analysis parameters.

A problem to be solved by the present invention is to provide a technique capable of easily obtaining an appropriate analysis result when analyzing various kinds of data such as measurement data, obtained by measuring a sample using an analyzing device, using an analysis parameter.

### SOLUTION TO PROBLEM

A first aspect of the present invention made to solve the above problem is a method for analyzing data to be analyzed by setting values respectively for one or a plurality of analysis parameters and using a predetermined analysis program, and includes:

a learning parameter set creation step of creating a plurality of learning parameter sets in which at least one value of the one or plurality of analysis parameters is different from each other;

a learning parameter set determination step of determining a learning parameter set suitable for each of a plurality of pieces of reference data based on a predetermined standard by executing an analysis using the analysis program and using each of the plurality of learning parameter sets on each of the plurality of pieces of reference data;

a reference data group creation step of associating the plurality of learning parameter sets, respectively, with reference data groups each of which is a group of pieces of reference data for which the learning parameter set is determined to be suitable for analysis in the learning parameter set determination step;

an analysis target data input step of inputting analysis target data;

an actual analysis parameter set determination step of determining an actual analysis parameter set by obtaining a commonality between the analysis target data and each of the reference data groups based on a predetermined standard and obtaining a value suitable for analysis of the analysis target data for each of the one or plurality of analysis parameters from the learning parameter sets associated respectively with the reference data groups based on the commonality; and

an actual analysis step of executing analysis of the analysis target data by the analysis program using the actual analysis parameter set.

In the data analyzing method according to the present invention, first, the plurality of learning parameter sets in which at least one value of the one or plurality of analysis parameters used for the data analysis is different from each other are created. Then, each of the plurality of pieces of reference data is analyzed by the analysis program using each of the plurality of learning parameter sets to determine the learning parameter set suitable for analysis based on the predetermined standard. This can be performed by, for example, obtaining an evaluation value indicating the validity of an analysis result, obtained by executing the analysis by the analysis program using each of the plurality of created learning parameter sets, for each of the plurality of pieces of reference data, and setting one having the highest evaluation value as the optimum learning parameter set. Alternatively, one having an evaluation value equal to or higher than a predetermined standard value may be used as the learning parameter set suitable for analysis. In the former case, one learning parameter set suitable for the analysis is determined for each of the reference data. In the latter case, one or a plurality of learning parameter sets are determined.

Subsequently, the reference data group which is the group of pieces of reference data for which the learning parameter set is determined to be suitable for analysis in the learning parameter set determination step is created for each of the plurality of learning parameter sets. As a result, pieces of reference data having the common learning parameter set suitable for analysis are grouped, and information that serves as the basis for determining a parameter set used for analysis of analysis target data can be obtained. When a plurality of parameter sets suitable for analysis are determined for one reference data in the previous learning parameter set determination step, the reference data may be included in the plurality of pieces of reference data groups.

Next, the analysis target data is input. Then, the actual analysis parameter set is determined by obtaining values suitable for analysis of the analysis target data for each of the one or plurality of analysis parameters based on the commonality between the analysis target data and the reference data group according to the predetermined standard. This predetermined standard differs depending on a kind of data to be analyzed. For example, when the data to be analyzed is a TICC waveform of GCMS data, a reference data group formed of pieces of reference data having a peak having a shape close to a peak of the analysis target data can be set as a reference data group having a high commonality.

The actual analysis parameter set determination step can be performed by, for example, determining a reference data group having the highest commonality with the analysis target data, and using a learning parameter set corresponding to the reference data group as the actual analysis parameter set without any change. In this manner, a parameter set number, associated with the reference data group having the highest commonality, is selected when predicting one of the parameter set numbers assigned to the plurality of learning parameter sets. This is a case where the set of the one or plurality of parameters is handled as one “parameter set” and any parameter set to be used for analysis is considered. This is an “identification” approach in machine learning terms.

In addition, an approach of directly associating each analysis parameter value with a reference data group (each reference data group may be formed of only one reference data) and estimating a value of each analysis parameter to be used in analysis of analysis target data is also conceivable as another method of performing the actual analysis parameter set determination step. This is a “regression” approach in machine learning terms. In the case of regression, for a certain analysis parameter, regression analysis can be performed based on a commonality (for example, similarity in TICC waveform) between analysis target data and each reference data group (or each reference data) even if a learning parameter set includes only two values (for example, 5 and 10) to obtain an intermediate value (for example, 7) that is neither of the above two values as the optimum analysis parameter value for the analysis of analysis target data. Such regression analysis can also be performed individually for one or a plurality of analysis parameters, or collectively (that is, in units of parameter sets) for the one or plurality of analysis parameters. Finally, the analysis of analysis target data is executed by the analysis program using the actual analysis parameter set formed of the values of the one or plurality of analysis parameters obtained by the above regression analysis.

In this manner, in the data analyzing method according to the present invention, the one or plurality of pieces of reference data having the common learning parameter set suitable for analysis are grouped as the reference data group by the analysis using the plurality of pieces of reference data prior to the analysis of analysis target data. Then, values suitable for the analysis of analysis target data are obtained for each of the one or plurality of analysis parameters from the learning parameter set associated with the reference data group based on the commonality between the analysis target data and the reference data group, and these values are determined as the actual analysis parameter set. Therefore, it is unnecessary for the user to set the analysis parameter value by himself/herself. In addition, it is possible to easily obtain an appropriate analysis result since the parameter set suitable for the analysis of analysis target data is uniquely determined. In addition, results thus obtained do not vary depending on the skill level of the user.

A second aspect of the present invention made to solve the above problem is a method for creating a learning model, used to determine values of one or a plurality of analysis parameters used when analyzing data to be analyzed by a predetermined analysis program, and includes:

a learning parameter set creation step of creating a plurality of learning parameter sets in which at least one value of the one or plurality of analysis parameters is different from each other;

a learning parameter set determination step of determining a learning parameter set suitable for each of a plurality of pieces of reference data based on a predetermined standard by executing an analysis using the analysis program and using each of the plurality of learning parameter sets on each of the plurality of pieces of reference data;

a reference data group creation step of associating the plurality of learning parameter sets, respectively, with reference data groups each of which is a group of pieces of reference data for which the learning parameter set is determined to be suitable for analysis in the learning parameter set determination step; and

a learning model creation step of creating a learning model by machine learning in which the plurality of learning parameter sets associated respectively with the reference data groups are used as learning data.

In the learning model creating method for data analysis, which is the second aspect of the present invention, the learning model is created by the machine learning which uses, as the learning data, the plurality of learning parameter sets associated respectively with the reference data groups, created by performing the learning parameter set creation step, the learning parameter set determination step, and the reference data group creation step similar to those of the data analyzing method of the first aspect. In recent years, various methods of machine learning have been proposed (for example, Patent Literature 1), and the machine learning can use, for example, deep learning, the convolution neural network (CNN), a support vector machine (SVM) and AdaBoost. The learning model thus created can be suitably used in the actual analysis parameter set determination step of the data analyzing method which is the first aspect of the present invention.

Further, a third aspect of the present invention made to solve the above problem is a device that analyzes data to be analyzed by setting values respectively for one or a plurality of analysis parameters and using a predetermined analysis program, and includes:

a learning parameter set creator configured to create a plurality of learning parameter sets in which at least one value of the one or plurality of analysis parameters is different from each other;

a learning parameter set determiner configured to determine a learning parameter set suitable for each of a plurality of pieces of reference data based on a predetermined standard by executing an analysis using the analysis program and using each of the plurality of learning parameter sets on each of the plurality of pieces of reference data;

a reference data group creator configured to associate the plurality of learning parameter sets, respectively, with reference data groups each of which is a group of pieces of reference data for which the learning parameter set is determined to be suitable for analysis by the learning parameter set determiner;

an analysis target data input unit configured to input analysis target data;

an actual analysis parameter set determiner configured to determine an actual analysis parameter set by obtaining a commonality between the analysis target data and each of the reference data groups based on a predetermined standard and obtaining a value suitable for analysis of the analysis target data for each of the one or plurality of analysis parameters from the learning parameter sets associated respectively with the reference data groups based on the commonality; and

an actual analysis executer configured to execute analysis of the analysis target data by the analysis program using the actual analysis parameter set.

### Advantageous Effects of Invention

It is possible to easily obtain the appropriate analysis result by using a data analyzing method, a data analyzing device, or a learning model creating method for data analysis according to the present invention when analyzing various kinds of data such as measurement data, obtained by measuring the sample using the analyzing device, using the analysis parameters.

### BRIEF DESCRIPTION OF DRAWINGS

FIG. 1 is a configuration diagram of a main part of an analysis system that combines a control and processing device, which is one example of a data analyzing device according to the present invention, and a gas chromatograph mass spectrometer.

FIG. 2 is a flowchart relating to one example of a data analyzing method according to the present invention.

FIG. 3A is an example of a heat map of three-dimensional data obtained by measuring a sample using a gas chromatograph mass spectrometer, and FIG. 3B is an example of a total ion current chromatogram.

FIG. 4 is descriptions of analysis parameters used in an AMDIS.

FIG. 5 is some of learning parameter sets used in the present example.

FIG. 6 is a histogram illustrating analysis results of divided reference data using a plurality of learning parameter sets in the present example.

FIGS. 7A to 7C are overlaid illustrations of peaks for each of three kinds of learning parameter sets used in the present example where the learning parameter set is optimum for analysis.

FIG. 8 is a configuration of data used for evaluation of a learning model created by machine learning.

FIG. 9 is a view for describing a structure of a convolutional neutral network used in machine learning in the present example.

FIG. 10 is hyperparameters and a network configuration of a convolutional neutral network with the highest percentage of correct responses in the present example.

FIG. 11 is the percentage of correct responses when an analysis process of selecting the optimum parameter set according to a learning model of the present example is evaluated by 5-fold cross-validation.

FIG. 12 is a graph for describing a process of extracting divided analysis target data from analysis target data.

FIG. 13 is a conceptual diagram of a data analyzing method and an analyzing device according to the present invention.

FIG. 14 is a block diagram of a modified example of the data analyzing device according to the present invention.

### DESCRIPTION OF EMBODIMENTS

Examples of a data analyzing method, a data analyzing device, and a learning model creating method for data analysis according to the present invention will be described below with reference to the drawings.

Data to be analyzed in the present example is three-dimensional GCMS data acquired by measurement using a gas chromatograph mass spectrometer. In addition, in the present example, an AMDIS is used as an analysis program, and a mass spectrum, purified by separating a peak of a waveform (TICC waveform) of a total ion current chromatogram obtained from GCMS data, is collated with mass spectra of various known substances stored in advance in a substance database (substance DB) to identify a substance contained in a sample and calculate an evaluation value (score) indicating the degree of matching. This score indicates that the reliability of substance identification is higher as a value of the score is higher.

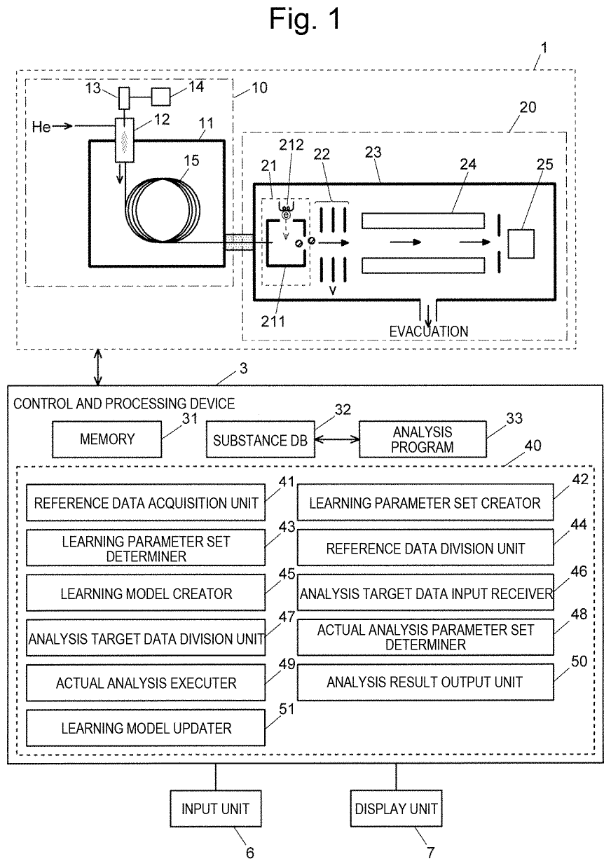

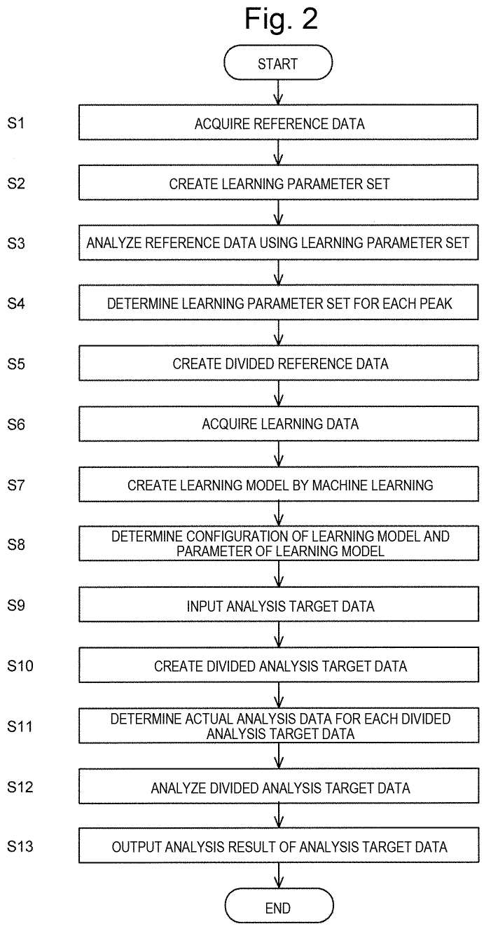

FIG. 1 is a configuration diagram of a main part of an analysis system including a data analyzing device of the present example, and FIG. 2 is a flowchart of a data analyzing method of the present example. The analysis system of the present example includes a gas chromatograph mass spectrometer 1 and a control and processing device 3.

The gas chromatograph mass spectrometer 1 comprises a gas chromatograph 10 and a mass spectrometer unit 20. In the gas chromatograph 10, liquid samples set in advance in an autosampler 14 are sequentially sent to an injector 13 and injected from the injector 13 into a sample vaporization chamber 12. In addition, a carrier gas such as helium is supplied to the sample vaporization chamber 12. The sample vaporization chamber 12 is heated, and the liquid sample injected from the injector 13 is vaporized and rides on the flow of the carrier gas to be sent into a capillary column 15 housed in a column oven 11. Various compounds contained in the sample gas are separated in a time direction while passing through the capillary column 15, and are sequentially introduced into the mass spectrometer unit 20.

The mass spectrometer unit 20 includes a vacuum chamber 23 that is evacuated by a vacuum pump (not illustrated), and an ion source 21, a lens electrode 22, a quadrupole mass filter 24, and an ion detector 25 are arranged inside the mass spectrometer unit 20. Substances in the sample gas introduced from the gas chromatograph 10 are sequentially introduced into the ion source 21. The ion source 21 is, for example, an electron ionization (EI) source, and ions are generated by irradiating the sample gas introduced into an ionization chamber 211 with thermions generated by a filament 212. The ions generated by the ion source 21 are converged by the lens electrode 22 and separated by the quadrupole mass filter 24 according to a mass-to-charge ratio, and then, detected by the ion detector 25. An output signal from the ion detector 25 is stored in a memory 31 of the control and processing device 3.

The control and processing device 3 has a function as an analysis controller that controls each part of the gas chromatograph mass spectrometer 1, and a function of processing data obtained by measurement using the gas chromatograph mass spectrometer 1 or the like. The latter corresponds to the data analyzing device according to the present invention. The control and processing device 3 includes the memory 31 and a substance database (substance DB) 32, and a predetermined analysis program (AMDIS in the present example) 33 is pre-installed in the control and processing device 3. The substance database 32 is a database used to identify a substance contained in a sample in data analysis according to the analysis program 33. Information, such as a substance name, a chemical formula, a theoretical retention time, and a mass spectrum, are stored in association for each of a large number of known substances.

The control and processing device 3 further includes a reference data acquisition unit 41, a learning parameter set creator 42, a learning parameter set determiner 43, a reference data division unit 44, a learning model creator 45, an analysis target data input receiver 46, an analysis target data division unit 47, an actual analysis parameter determiner 48, an actual analysis executer 49, an analysis result output unit 50, and a learning model updater 51 as functional blocks. The entity of the control and processing device 3 may be a personal computer, and these functional blocks are embodied by executing a data analysis program 40 pre-installed in the control and processing device 3 on a processor. In addition, an input unit 6, such as a mouse and a keyboard, and a display unit 7 are connected to the control and processing device 3.

Next, a procedure for analyzing GCMS data in the present example will be described together with an actual analysis example with reference to the flowchart of FIG. 2. In addition, Steps S1 to S8 in the flowchart of FIG. 2 are procedures of one embodiment of a learning model creating method according to the present invention.

When a user instructs acquisition of reference data with an operation through the input unit 6, the reference data acquisition unit 41 operates each part of the gas chromatograph mass spectrometer 1, introduces samples set in advance on the autosampler 14 by the user sequentially into the gas chromatograph mass spectrometer 1, and measures each of the samples. Pieces of GCMS data obtained by measuring the respective samples are sequentially stored in the memory 31 of the control and processing device 3. Although the case of acquiring reference data by actually measuring the samples has been described here, reference data acquired in advance by the reference data acquisition unit 41 may be read from the memory 31 according to the user's instruction. In this manner, a plurality of pieces of reference data are acquired (Step S1).

In the present example, 32 kinds of biological samples containing some or all of 504 kinds of known substances were prepared, and 32 pieces of GCMS data were acquired by executing measurement using the gas chromatograph mass spectrometer 1 for each of the biological samples. For each of these 504 kinds of known substances, information on a retention time and a mass spectrum are stored in the substance database 32. In addition, a measurement time was set to 4 to 24 minutes after sample injection, and measurement was performed by 24000 scans in a mass-to-charge ratio range of 80 to 500 for this measurement time.

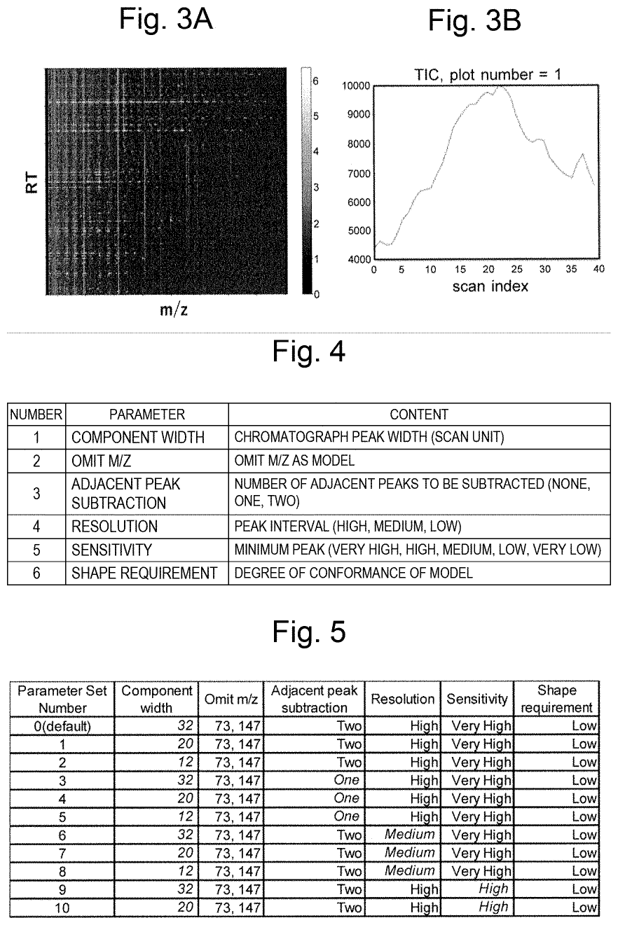

FIG. 3A illustrates an example of GCMS data. This example is obtained by converting a peak intensity of a graph having the retention time (RT) and mass-to-charge ratio (m/z) as two axes into the logio scale and expressing a converted value by a difference between cold and warm colors (however, monochrome display is used in FIG. 3A). In addition, a part of a TICC waveform (data for 40 scans) created from the GCMS data is illustrated in FIG. 3B. A sample containing a large number of substances as in the present example contains a plurality of substances having the same or similar retention times in many cases. A plurality of substances are mixed in an eluate eluted from the chromatograph at the retention time of those substances or the time before and after the retention time. As a result, mass peaks, derived from the plurality of substances, are mixed in a mass spectrum at the retention time of those substances or the time before and after the retention time, so that peaks of the TICC waveform obtained by integrating these mass peaks also appear as peaks (convolution peaks) where the peaks derived from the plurality of substances are superimposed on each other as illustrated in FIG. 3B.

When the user instructs creation of a learning parameter set with an operation through the input unit 6, the learning parameter set creator 42 executes the analysis program 33 pre-installed in the control and processing device 3 to display a screen for setting parameters on the display unit 7. The analysis program of the present example is the AMDIS. The AMDIS uses six analysis parameters: a component width, omit m/z, adjacent peak subtraction, resolution, a sensitivity, and a shape requirement. FIG. 4 illustrates a content of each parameter. In the present example, 45 kinds of parameter sets were created by lowering the adjacent peak subtraction from two to one and lowering the resolution from high to medium using the initial value (Parameter Set Number: 0) as a standard. FIG. 5 illustrates some of them (initial values and 10 kinds of parameter sets). Although the order in which the learning parameter set is created after acquiring the reference data has been described here, the execution order of the both may be reversed, or the both may be performed in parallel. In addition, the learning parameter set creator 42 may read a learning parameter set created in advance from the memory 31 in response to the user's instruction. In this manner, the plurality of learning parameter sets are created (Step S2).

If the reference data is acquired and the learning parameter sets are created, the learning parameter set determiner 43 executes analysis by the AMDIS for each of 32 pieces of GCMS data by individually using the 45 kinds of learning parameter sets (Step S3). Specifically, for each pair of GCMS data and a learning parameter set, peaks of a TICC waveform included in the GCMS data are purified, and a mass spectrum corresponding to each peak is collated with a mass spectrum stored in the substance database 32 to identify a substance corresponding to each peak. Further, an evaluation value (score) is obtained from the degree of matching of the mass spectrum. The AMDIS obtains scores between 1 to 100 indicating the identification and the reliability of the substance identification. In the present example, a peak is set as “identified”, when a score is 60 or more, and a peak with a score of less than 60 is set as “unidentified”. For the peak where the identification has been completed, an identified substance name, a retention time, a parameter set number used for analysis, and a score are stored in association in the memory 31.

Next, the learning parameter set determiner 43 determines the optimum learning parameter set for identification, for each of the peaks of the 32 pieces of GCMS data (Step S4). When peaks with the same retention time are identified by analysis using a plurality of learning parameter sets, a learning parameter set with which an analysis result with the highest score is obtained is set as the optimum learning parameter set for the peak identification among the plurality of learning parameter sets. In addition, when there are a plurality of maximum scores, one with a smaller learning parameter set number is set as the optimum learning parameter set. The above processing is performed for all peaks (peaks at which substances have been identified) to determine the optimum learning parameter set. However, when a difference between a retention time of a peak and a theoretical retention time of an identified substance is greater than 0.25 minutes, it was determined as misidentification regardless of a score, and a learning parameter set having the next largest score and a difference in retention time of 0.25 minutes or less was set as the optimum learning parameter set for identifying the peak.

When there are a plurality of maximum scores, one with the smaller learning parameter set number is set as the optimum learning parameter set in the present example. Alternatively, one with a larger learning parameter set number may be set as the optimum learning parameter set, or the both may set as the optimum learning parameter sets.

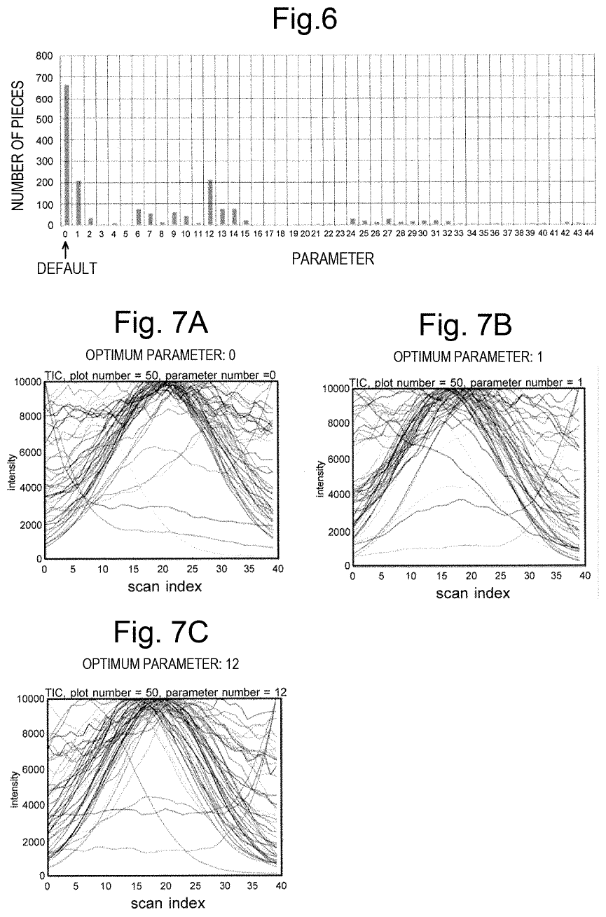

If the optimum learning parameter sets are determined for the all peaks, the reference data division unit 44 extracts (divides the reference data) data for 40 scans centered on the retention time (peak top) for each peak (Step S5). In the present example, 1806 pieces of data (divided reference data) were obtained as a result. FIG. 6 illustrates the relationship between these 1806 pieces of data and the optimum learning parameter sets (histogram illustrating the number of pieces of divided reference data associated with learning parameter sets, respectively).

In the present example, the number of pieces of divided reference data for which the learning parameter 0 having the initial values of the analysis parameters is determined as the optimum learning parameter set was 667, and the number of pieces of divided reference data for which other learning parameter sets were determined as the optimum learning parameter sets was 1,139. In this manner, there is a certain percentage of data in which the initial values of the analysis parameters are not optimal in many cases.

Next, the learning model creator 45 selects three learning parameter sets (0, 1, and 12) in which the number of associated divided reference data is 200 or more, as candidates for an actual analysis parameter set used for actual analysis, from among the 45 kinds of learning parameter sets, and extracts the selected learning parameter sets together with the divided reference data associated with each of the learning parameter sets. Here, a group of one or a plurality of pieces of divided reference data associated with one learning parameter set constitutes one reference data group. That is, the learning model creator 45 of the present example has a function as a reference data group creator according to the present invention. Data created in this manner becomes learning data used in machine learning which will be described later (Step S6). Although it is also possible to extract a learning parameter set with which less than 200 pieces of divided reference data are associated, it is difficult to identify a characteristic part (for example, peak shape) common to the divided reference data by machine learning if the number of associated divided reference data is too small. Any number of pieces of data that is required for machine learning analysis depends on a kind of data to be analyzed or a content of analysis without being limited to the present example. In general, it is desirable that at least several tens to 100 pieces of (divided) reference data be associated with the learning parameter set extracted at this stage.

FIGS. 7A to 7C are overlaid illustrations of TICC waveforms of the divided reference data associated with the learning parameter set (data for 40 scans standardized with its maximum intensity) for each of the three learning parameter sets. FIG. 7A illustrates Parameter Set 0 (initial value), FIG. 7B illustrates Parameter Set 1, and FIG. 7C illustrates Parameter Set 12. It is difficult to find a characteristic peak shape of each group (reference data group) only by visually comparing peak shapes of the TICC waveforms included in FIGS. 7A to 7C. In addition, many peaks have peak tops at the center, but some peaks do not seem to exist at the center at first glance. It can be seen that peaks, which are hardly extracted visually, are also extracted by using the analysis program such as the AMDIS.

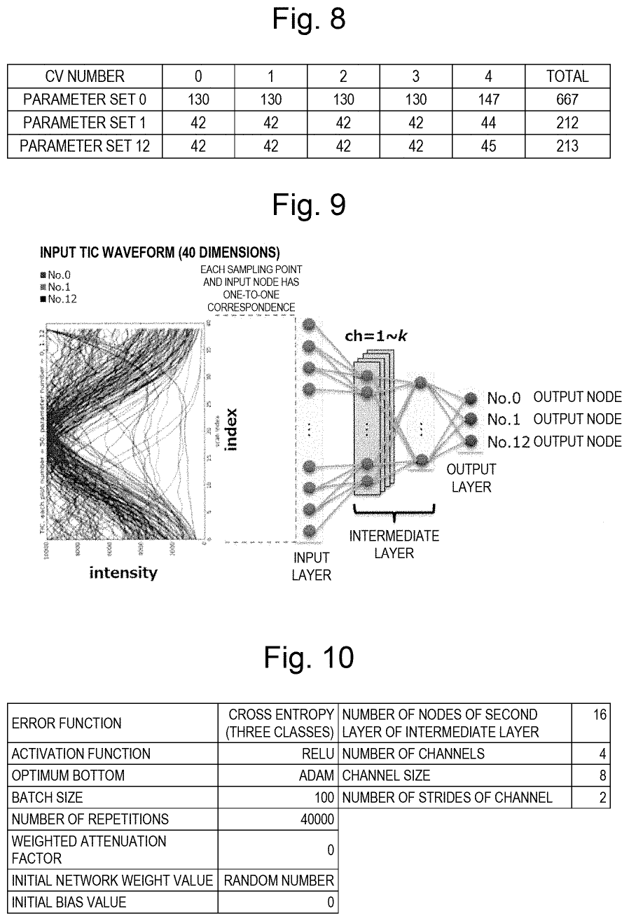

Next, the learning model creator 45 creates a learning model by machine learning that uses, as learning data, a total of 1,092 pieces of divided reference data (Parameter Set 0: 667, Parameter Set 1: 212, and Parameter Set 12: 213) associated with each of the three learning Parameter Sets 0, 1 and 12 (Step S7). In the present example, a learning model was constructed using a convolutional neural network (CNN). In addition, a 5-fold cross validation (CV) method was used as a method for evaluating the learning model. The 5-fold CV method evaluates the performance of a model based on an average value of five percentages of correct responses obtained by sequentially performing processes of constructing a learning model using data with CV numbers 1 to 4, and applying the learning model to data with CV number 0 to calculate the percentage of correct responses for the data with CV number 0 and then constructing a learning model using the data with CV numbers 0, 2 to 4 and applying the learning model to the data with CV number 1 to calculate the percentage of correct responses for the data of CV number 1. In such a cross-validation method, “data used for model construction” and “data used for evaluation of the constructed model” are different, and thus, this method can be referred to as a method for evaluating prediction performance for unknown data. In the present example, the divided reference data is divided into five pieces of data (CV numbers 0 to 4) as illustrated in FIG. 8.

The above learning model in the present example can be regarded as a kind of discriminator that outputs a result according to characteristics of input data. Although the CNN is used in the present example, it is also possible to construct a learning model using deep learning, a support vector machine (SVM), AdaBoost, or the like other than the CNN.

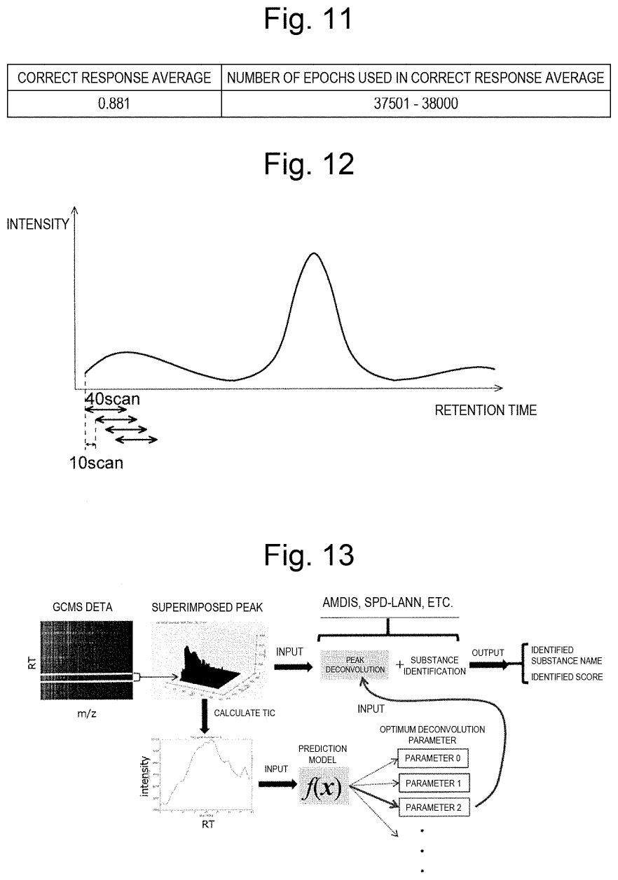

FIG. 9 is a schematic configuration diagram of a network of the CNN used to create the learning model in the present example. In the present example, one-dimensional convolution was performed. Then, hyperparameters and a network configuration (for example, Non-Patent Literature 3) with the highest percentage of CV correct responses were determined based on this learning model (Step S8). The results are illustrated in FIG. 10. As illustrated in FIG. 11, an average value of the percentages of correct responses obtained by these hyperparameter and network configuration was 88.1%. In other words, a prediction model that can predict the optimum parameter set with a probability of about 90% for unknown data (divided analysis target data obtained by extracting a part where a peak exists from GCMS data of a sample whose containing substance is unknown) was constructed.

In the present example, 1,092 pieces of divided reference data are used as the learning data as described above. Among these, the number of pieces of data for which initial values (Parameter Set 0) of the AMDIS analysis parameters were the optimum parameter sets was 667, that is, accounts for 61.1% of the learning data. On the other hand, the percentage of correct responses of 88.1% was obtained in the learning model created in the present example. From these comparisons, it can be said that the possibility of selecting the optimum parameter set for data analysis and identifying the substance contained in the sample with the highest accuracy has increased as compared with the related art by using the learning model of the present example.

When the learning model is created by the learning model creator 45, the analysis target data input receiver 46 displays a screen for inputting data to be analyzed on the display unit 7. The user measures a sample set in the autosampler 14 with the gas chromatograph mass spectrometer 1 and inputs the acquired GCMS data as analysis target data in the same manner as the time of acquiring the reference data. Alternatively, the analysis target data stored in advance in the memory 31 is read and input in the case of analyzing already measured data. The analysis target data of the present example is GCMS data obtained by 24000 scans of the mass-to-charge ratio range of 80 to 500 for 4 to 24 minutes after sample injection, which is similar to the reference data. In this manner, the data to be analyzed is input as the analysis target data (Step S9). Note that the measurement conditions for the analysis target data are not necessarily the same as the measurement conditions for the reference data.

When the analysis target data is input, the analysis target data division unit 47 extracts data for 40 scans while shifting an extraction start position by, for example, 10 scans from the side where a retention time of the input analysis target data is shorter as illustrated in FIG. 12. As a result, 2,397 pieces of divided analysis target data are created from the analysis target data (Step S10).

When the divided analysis target data is obtained, the actual analysis parameter determiner 48 inputs the divided analysis target data one by one into the learning model as unknown data to output a parameter set most suitable for the analysis of the divided analysis target data from among Parameter Sets 0, 1, and 12. The learning model determines a reference data group having the highest commonality with characteristics of a peak included in the divided analysis target data, and determines an actual analysis parameter set corresponding to the reference data group (Step S11).

Normally, not every divided analysis target data generated from one analysis target data includes a peak, and only some of them have peaks. For divided analysis target data that does not include any peak, there is no reference data group that has the same characteristics as the data, and thus, there is no optimum parameter set. Therefore, it is determined that there is no analysis target (peak) for such divided analysis target data, and the optimum parameter set is selected only for the divided analysis target data in which the analysis target (peak) exists.

The actual analysis executer 49 performs analysis by the AMDIS using the parameter set selected by the learning model to purify the peaks, and identifies a substance corresponding to each of the peaks to obtain a score (Step S12). When the actual analysis executer 49 completes the identification of the substance corresponding to the peak, the analysis result output unit 50 displays (outputs) the name, retention time, and score of the identified substance on the display unit 7 (Step S13). In addition to these information, a number of the parameter set used for the peak identification may be output. In addition, it is also possible to add a configuration in which identification results are discarded (or a warning display is added) when the retention time of the identified peak and the theoretical retention time of the identified substance differ by a predetermined time (for example, 0.25 minutes) or more in Step S12. As a result, it is possible to exclude the possibility of misidentification due to accidental matching of mass spectra and to improve the identification accuracy.

The main object of the data analyzing method and device in the present example is the above-described analysis of analysis target data, but the data analyzing device of the present example further includes the learning model updater 51.

When a predetermined number (for example, 30) of pieces of analysis target data, which has been analyzed by the actual analysis executer 49, (hereinafter referred to as “analyzed data”) is accumulated, the learning model updater 51 sets these pieces of analyzed data as the reference data described above. When the reference data is set in this manner, the same processes as those in Steps S1 to S8 described above are performed in order. Then, the hyperparameters and network configuration of the learning model are adjusted again such that the percentage of correct responses in the 5-fold CV method is the highest, and the learning model is updated. In this manner, it is possible to update the learning model so as to be capable of handling a wider variety of data by sequentially using the analyzed data as the reference data. Although the configuration in which the learning model updater 51 updates the learning model every time the predetermined number of pieces of analyzed data is accumulated is adopted here, the learning model may be updated (reconstructed) every time analyzed data is generated. Although the case of updating the learning model by on-line learning (sequential learning) that executes the machine learning using only the newly added analyzed data as the reference data has been described as an example, the learning model may be updated by batch learning using both the reference data and analyzed data already used for machine learning.

FIG. 13 schematically illustrates the concept of the data analyzing method and the analyzing device of the present example. As illustrated in FIG. 13, in the present example, a learning model (prediction model f(x)) as a discriminator, which outputs a result f(x) according to characteristics of input data x, is created in advance by machine learning. When GCMS data to be analyzed is input, divided analysis target data is created from the GCMS data. Further, waveform data of a total ion current chromatogram created from the divided analysis target data is input to the learning model, and the optimum parameter set is output. Then, purification of a peak (peak deconvolution or the like) by the AMDIS and identification of a substance corresponding to the peak are performed using the optimum parameter set as an analysis parameter, and the results (identification substance name and identification score) are output.

In the data analyzing method and data analyzing device of the present example, one of the learning parameter sets is selected as the optimum parameter set (actual analysis parameter set) for the data to be analyzed using the learning model created by the machine learning, and analysis by the AMDIS is performed using the actual analysis parameter set. Therefore, it is unnecessary for the user to change the analysis parameter value by himself/herself, and it is possible to easily obtain the optimum analysis result with a high probability. In addition, there is no difference in the analysis result depending on the skill level of the user. Further, it is possible to constantly analyze various kinds of data with high accuracy since the learning model is updated every time the predetermined number of pieces of analyzed data is accumulated.

Next, a modified example of the data analyzing device according to the present invention will be described. Although both the learning model creation and the data analysis are performed in the data analyzing device (the control and processing device 3) of the above example, data is analyzed using a learning model created in advance in a data analyzing device of the modified example.

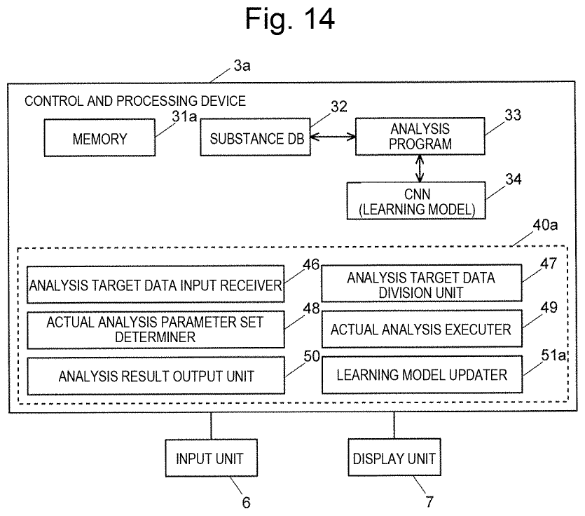

FIG. 14 is a block diagram of a control and processing device 3a which is the modified example of the data analyzing device according to the present invention. Components common to those of the control and processing device 3 of the above example are denoted by the same reference signs, and the description thereof will be omitted as appropriate. The entity of the control and processing device 3a of the modified example is also a personal computer, and each functional block illustrated in FIG. 14 is embodied by executing a data analysis program 40a, which is similar to the above example.

A learning model (CNN) 34 corresponding to an analysis program (AMDIS in the above example) is pre-installed in this control and processing device 3a, and a learning parameter set used when constructing the learning model 34 is stored in a memory 31a, which is different from the control and processing device 3 of the above example. This learning model 34 is obtained by porting the learning model 34 created by executing Steps S1 to S8 described in the above example, and is installed at the stage before shipment of the personal computer configured as the control and processing device 3a of the modified example.

Therefore, a user of the control and processing device 3a of the modified example can analyze data using the learning model by executing only Steps S9 to S13 without executing S1 to S8 of the above example by himself/herself.

The control and processing device 3a of the modified example also has a learning model updater 51a, which is similar to the above example. The learning model updater 50a appropriately updates parameters and network configuration of the learning model 34 every time a predetermined number of pieces of analyzed data is accumulated, which is similar to the above example. Note that the learning model is updated by either the batch learning or on-line learning in the above example, but the learning model is updated by on-line learning in the control and processing device 3a of the modified example.

The above example is given merely as an example and can be appropriately modified according to a gist of the present invention.

Although the configuration in which the learning parameter set determiner 43 determines the optimum learning parameter set for each peak is adopted in the above example, all the learning parameter sets for which scores (evaluation values) equal to or higher than a predetermined value have been obtained may be set as parameter sets suitable for analysis. Alternatively, it is also possible to set all the learning parameter sets with scores of a certain ratio (for example, 90%) or more relative to the highest score obtained for a peak of the same retention time, as parameter sets suitable for analysis. In these cases, the same peak data (divided reference data) is associated with a plurality of analysis parameters.

In addition, the configuration in which the divided analysis target data is created from the entire analysis target data and input to the learning model is adopted in the above example, but a portion where a peak (analysis target) exists may be extracted in advance from the analysis target data, and the divided analysis target data may be created only from the portion. For example, the analysis target data may be analyzed by the AMDIS to extract the peak using initial values of the analysis parameters without any change. Alternatively, another software for peak detection may be used to identify a portion where the peak exists from the analysis target data. Further, the user may identify a range regarded to have the peak by himself/herself.

Further, in the above example, a set of values of one or the plurality of analysis parameters is set as one learning parameter set, and one most suitable for analyzing the analysis target data among the plurality of learning parameters is set as the actual analysis parameter set. That is, the case of predicting one of categories, which are the parameter set numbers corresponding to the plurality of learning parameter sets prepared in advance, has been described as an example. This is an “identification” approach in machine learning terms.

However, the actual analysis parameter set can be determined by a “regression” approach. Specifically, the regression approach is an approach of directly associating each analysis parameter value with a reference data group (each reference data group may be formed of only one reference data) and directly estimating a value of each analysis parameter to be used in analysis of analysis target data is also conceivable. In this approach, for a certain analysis parameter, regression analysis can be performed based on a commonality (for example, similarity in TICC waveform) between analysis target data and each reference data group (or each reference data) even if a learning parameter set includes only two values (for example, 5 and 10) to obtain an intermediate value (for example, 7) that is neither of the above two values as the optimum analysis parameter value for the analysis of analysis target data. Such regression analysis can also be performed individually for each of one or a plurality of analysis parameters, or collectively (that is, in units of parameter sets) for the one or plurality of analysis parameters.

Although the case of identifying the substance contained in the sample using the three-dimensional data obtained by the measurement of the sample using the gas chromatograph mass spectrometer has been described in the above example, the data analyzing method, the data analyzing device, and the learning model creating method according to the present invention can be widely used for analysis of various kinds of data.

For example, Mass++ is one of software analyzing mass spectrometric data of a sample (see Non-Patent Literature 2). Mass++ is a software capable of performing analysis of reading LCMS data obtained by measuring a sample containing peptide or protein with a liquid chromatograph mass spectrometer (including MALDI), performing processing, such as chromatogram and mass spectrum smoothing, baseline removal, and peak detection, creating a peak list of mass spectra and send the peak list to a database search server (Mascot server) to identify peptide, and identifying protein predicted from the identified peptide. Even with Mass++, a score (reliability score) that indicates the reliability of identification of the identified peptide or protein is obtained similarly to the AMDIS.

Various analysis parameters are used when creating a list of mass spectra from LCMS data using Mass++. In addition, various analysis parameters are also used to identify a substance corresponding to the created peak list. Conventionally, it is necessary to use the initial values of these analysis parameters without any change for analysis, or to change the analysis parameters based on the user's own experience. However, the optimum identification result can be easily obtained by applying the present invention.

In addition, the present invention can be applied to analysis such as identification of a substance contained in a sample by analyzing spectroscopic spectrum data, obtained by measuring the sample using analyzing devices other than the chromatograph or the mass spectrometer, for example, a spectroscopic measuring device such as a Fourier transform infrared spectrophotometer, by a predetermined analysis program. Further, the present invention can also be used for analysis of data obtained by a nuclear magnetic resonance device (NMR), a near-infrared optical brain function imaging device (NIRS), or the like. Further, the present invention can also be used for analysis such as prediction of future stock price fluctuation data from the latest stock price fluctuation data based on past stock price fluctuation data. That is, the present invention can be applied to various kinds of data analysis as long as it is possible to define that an evaluation value increases (for example, the percentage of correct responses for a given question increases, the purity of a target substance increases, the power consumption decreases, or a profit increases) by performing analysis using the optimum analysis parameters.

In the above example, all the pieces of reference data (and analyzed data) are subjected to comprehensive analysis using the plurality of learning parameter sets to create the learning model by performing so-called supervised learning, which uses only learning data for which the optimum parameter set is known in advance for all peaks. However, it is also possible to create a learning model by semi-supervised learning that uses learning data added with peak data for which the optimum parameter set is unknown, in addition to this reference data.

The case where the batch learning and on-line learning are used as the techniques for machine learning has been described in the above example and modified example. In addition, it is possible to use various techniques such as transfer learning (learning an additional learning model using learning data belonging to a domain different from a domain in which the learning model has been created) and reinforcement learning (learning a behavior that maximizes a reward through trial and error while updating information on the behavior and a result in which the reward is applied as evaluation of the quality of the result obtained by a series of behaviors, instead of having no teacher that explicitly instructs an output for an input).

For example, it is possible to consider a case where a manufacturer of the personal computer, which is the control and processing device 3a of the modified example, has installed a CNN 34 to discriminate the quality of a cell of a clone cultured in its company, and a person who has purchased this product uses the CNN 34 not only to discriminate the quality of the cloned cell but also to discriminate the quality of a cell cultured with undifferentiated maintenance. That is, when the CNN 34 is used to analyze data acquired in an environment other than an environment under which the CNN 34 has been created, the learning model updater 51a updates the CNN 34 created for discrimination of the quality of the cloned cell with the data acquired in the other environment. Even when such transfer learning is performed, it is possible to use the configurations described in the above example and modified example. In addition, the transfer learning is also performed in a case where a learning model, created to remove noise from image data obtained by capturing a sample with an optical microscope and to perform analysis for detecting a characteristic structure of the sample is applied to analysis such as detection of a characteristic structure of a sample by removing noise from data acquired by mass spectrometry of the sample using an imaging mass spectrometer.

In addition, the method and device according to the present invention can also be used in a case of learning a behavior of adjusting a control parameter so as to maximize a reward using a peak intensity obtained as a result of measurement as the reward regarding the behavior of changing the control parameter such as voltage and temperature of a mass spectrometer.

### REFERENCE SIGNS LIST

1 . . . Gas Chromatograph Mass Spectrometer
10 . . . Gas Chromatograph Section
11 . . . Column Oven
12 . . . Sample Vaporization Chamber
13 . . . Injector
14 . . . Autosampler
15 . . . Capillary Column
20 . . . Mass Spectrometry Section
21 . . . Ion Source
211 . . . Ionization Chamber
212 . . . Filament
22 . . . Lens Electrode
23 . . . Quadrupole Mass Filter
23 . . . Vacuum Chamber
24 . . . Ion Detector
3, 3a . . . Control and Processing Device
31, 31a . . . Memory
32 . . . Substance Database
33 . . . Analysis Program
34 . . . CNN
40, 40a . . . Data Analysis Program
41 . . . Reference Data Acquisition Unit
42 . . . Learning Parameter Set Creator
43 . . . Learning Parameter Set Determiner
44 . . . Reference Data Division Unit
45 . . . Learning Model Creator
46 . . . Analysis Target Data Input Receiver
47 . . . Analysis Target Data Division Unit
48 . . . Actual Analysis Parameter Set Determiner
49 . . . Actual Analysis Executer
50 . . . Analysis Result Output Unit
51, 51a . . . Learning Model Updater
6 . . . Input Unit
7 . . . Display Unit

1. A method for analyzing data to be analyzed by setting values respectively for one or a plurality of analysis parameters and using a predetermined analysis program, the data analyzing method comprising:
a learning parameter set creation step of creating a plurality of learning parameter sets in which at least one value of the one or plurality of analysis parameters is different from each other;
a learning parameter set determination step of determining a learning parameter set suitable for each of a plurality of pieces of reference data based on a predetermined standard by executing an analysis using the analysis program and using each of the plurality of learning parameter sets on each of the plurality of pieces of reference data;
a reference data group creation step of associating the plurality of learning parameter sets, respectively, with reference data groups each of which is a group of pieces of reference data for which the learning parameter set is determined to be suitable for analysis in the learning parameter set determination step;
an analysis target data input step of inputting analysis target data as data that is not analyzed;
an actual analysis parameter set determination step of determining an actual analysis parameter set by obtaining a commonality between the analysis target data and each of the reference data groups based on a predetermined standard and obtaining a value suitable for analysis of the analysis target data for each of the one or plurality of analysis parameters from the learning parameter sets associated respectively with the reference data groups based on the commonality; and
an actual analysis step of executing analysis of the analysis target data by the analysis program using the actual analysis parameter set.

2. The data analyzing method according to claim 1, further comprising
a learning model creation step of creating a learning model by machine learning in which the plurality of learning parameter sets associated respectively with the reference data groups are used as learning data,
wherein a parameter set is determined using the learning model in the learning parameter set determination step.

3. The data analyzing method according to claim 2, wherein
the machine learning uses deep learning, a support vector machine, or AdaBoost.

4. The data analyzing method according to claim 2, further comprising
a learning model update step of executing the learning parameter set determination step using the analysis target data as the reference data to determine a learning parameter set suitable for the analysis, and performing the machine learning using the learning parameter set suitable for the analysis associated with the analysis target data as learning data.

5. The data analyzing method according to claim 1, wherein
the reference data and the analysis target data are mass chromatograms, total ion current chromatograms, mass spectra, spectroscopic spectra, or image data.

6. The data analyzing method according to claim 1, wherein
in the learning parameter set determination step, a parameter set suitable for the analysis is determined for some or all of pieces of divided reference data obtained by dividing the reference data, and
the reference data group is created by grouping the pieces of divided reference data in the reference data group creation step.

7. The data analyzing method according to claim 6, wherein
the analysis program extracts data of one or a plurality of peaks included in the analysis target data, and identifies a substance corresponding to the one or plurality of peaks by collating the extracted data with a database of known substances.

8. The data analyzing method according to claim 7, wherein
a degree of matching with data stored in the database regarding the identified substance is obtained for each piece of the data of one or plurality of peaks included in the analysis target data.

9. The data analyzing method according to claim 8, wherein
the predetermined standard in the optimum parameter determination step allows data with a highest degree of matching to be set as an optimum learning parameter set.

10. The data analyzing method according to claim 6, wherein
data, obtained by measuring a sample to be analyzed using an analyzing device, is divided based on a predetermined standard to create a plurality of pieces of divided analysis target data, and
some or all of the plurality of pieces of divided analysis target data are input as the analysis target data in the analysis target data input step.

11. The measurement data analyzing method according to claim 10, wherein
the divided analysis target data is data of one or a plurality of peaks.

12. The measurement data analyzing method according to claim 1, wherein
the actual analysis parameter set is determined only when there is a reference data group having a commonality equal to or higher than a predetermined standard in the actual analysis parameter set determination step.

13. A device that analyzes data to be analyzed by setting values respectively for one or a plurality of analysis parameters and using a predetermined analysis program, the measurement data analyzing device comprising:
a learning parameter set creator configured to create a plurality of learning parameter sets in which at least one value of the one or plurality of analysis parameters is different from each other;
a learning parameter set determiner configured to determine learning parameter set suitable for each of a plurality of pieces of reference data based on a predetermined standard by executing an analysis using the analysis program and using each of the plurality of learning parameter sets on each of the plurality of pieces of reference data;
a reference data group creator configured to associate the plurality of learning parameter sets, respectively, with reference data groups each of which is a group of pieces of reference data for which the learning parameter set is determined to be suitable for analysis by the learning parameter set determiner;
an analysis target data input unit configured to input analysis target data;
an actual analysis parameter set determiner configured to determine an actual analysis parameter set by obtaining a commonality between the analysis target data and each of the reference data groups based on a predetermined standard and obtaining a value suitable for analysis of the analysis target data for each of the one or plurality of analysis parameters from the learning parameter sets associated respectively with the reference data groups based on the commonality; and
an actual analysis executer configured to execute analysis of the analysis target data by the analysis program using the actual analysis parameter set.

14. A method for creating a learning model, used to determine values of one or a plurality of analysis parameters used when analyzing data to be analyzed by a predetermined analysis program, the learning model creating method comprising:
a learning parameter set creation step of creating a plurality of learning parameter sets in which at least one value of the one or plurality of analysis parameters is different from each other;
a learning parameter set determination step of determining a learning parameter set suitable for each of a plurality of pieces of reference data based on a predetermined standard by executing an analysis using the analysis program and using each of the plurality of learning parameter sets on each of the plurality of pieces of reference data;
a reference data group creation step of associating the plurality of learning parameter sets, respectively, with reference data groups each of which is a group of pieces of reference data for which the learning parameter set is determined to be suitable for analysis in the learning parameter set determination step; and
a learning model creation step of creating a learning model by machine learning in which the plurality of learning parameter sets associated respectively with the reference data groups are used as learning data.
